(19) United States
(12) Patent Application Publication
(10) Pub. No.: US 2026/0100087 A1
(43) Pub. Date: Apr. 9, 2026

(54) ELECTRONIC GAMING SYSTEMS AND METHODS HAVING ACTIVATABLE AND DEACTIVATABLE MATRIX POSITIONS

(71) Applicant: Aristocrat Technologies, Inc., Las Vegas, NV (US)

(72) Inventors: Eric Boese, Decatur, GA (US); Ronald Williams, II, Atlanta, GA (US); Jae Yi, Alpharetta, GA (US); Keith Menchin, Atlanta, GA (US)

(21) Appl. No.: 19/047,166

(22) Filed: Feb. 6, 2025

Related U.S. Application Data
(60) Provisional application No. 63/703,571, filed on Oct. 4, 2024.

(51) Int. Cl. G07F 17/32; G07F 17/34

(52) U.S. Cl. CPC G07F 17/3211; G07F 17/34

(57) ABSTRACT

An electronic gaming system is provided. The electronic gaming system may be configured to: (1) in response to a bonus feature being triggered, generate a game interface including a plurality of matrix positions; (2) in response to the bonus feature being triggered, record each of the matrix positions as being in an active state; (3) for each matrix position recorded as being in the active state, perform a first random determination; (4) cause a cash on reel (COR) symbol to be displayed in at least one of the matrix positions based on the first random determination; and (5) record each matrix position in which a COR symbol is not displayed following the first random determination as being in an inactive state.

### CROSS-REFERENCE TO RELATED APPLICATIONS

This application claims the benefit of priority to U.S. Provisional Patent Application Ser. No. 63/703,571, filed Oct. 4, 2024, and entitled “ELECTRONIC GAMING SYSTEMS AND METHODS HAVING ACTIVATABLE AND DEACTIVATABLE MATRIX POSITIONS,” the contents and disclosures of which are hereby incorporated herein in their entirety.

### TECHNICAL FIELD

The field of disclosure relates generally to electronic gaming, and more specifically, to systems and methods that generate a game matrix having matrix positions that may be activated or deactivated in response to predefined triggers.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming system is provided. The electronic gaming system may include at least one memory with instructions stored thereon. The at least one memory may be further configured to record a state of a plurality of matrix positions. The electronic gaming system may further include at least one processor in communication with the at least one memory, wherein the instructions, when executed by the at least one processor, cause the at least one processor to: (1) in response to a bonus feature being triggered, generate a game interface including the plurality of matrix positions; (2) in response to the bonus feature being triggered, record each of the matrix positions as being in an active state; (3) for each matrix position recorded as being in the active state, perform a first random determination; (4) cause a cash on reel (COR) symbol to be displayed in at least one of the matrix positions based on the first random determination; and (5) record each matrix position in which a COR symbol is not displayed following the first random determination as being in an inactive state.

In another aspect, a method for electronic gaming is provided. The method may be performed by at least one processor in communication with at least one memory configured to record a state of a plurality of matrix positions. The method may include: (1) in response to a bonus feature being triggered, generating a game interface including the plurality of matrix positions; (2) in response to the bonus feature being triggered, recording each of the matrix positions as being in an active state; (3) for each matrix position recorded as being in the active state, performing a first random determination; (4) causing a COR symbol to be displayed in at least one of the matrix positions based on the first random determination; and (5) recording each matrix position in which a COR symbol is not displayed following the first random determination as being in an inactive state.

In another aspect, at least one non-transitory computer-readable storage media having instructions embodied thereon is provided. When executed by at least one processor in communication with at least one memory configured to record a state of a plurality of matrix positions, the instructions may cause the at least one processor to: (1) in response to a bonus feature being triggered, generate a game interface including the plurality of matrix positions; (2) in response to the bonus feature being triggered, record each of the matrix positions as being in an active state; (3) for each matrix position recorded as being in the active state, perform a first random determination; (4) cause a COR symbol to be displayed in at least one of the matrix positions based on the first random determination; and (5) record each matrix position in which a COR symbol is not displayed following the first random determination as being in an inactive state.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 illustrates an exemplary process for electronic gaming according to an exemplary embodiment of the present disclosure.

FIG. 5A illustrates an exemplary game interface according to an exemplary embodiment of the present disclosure in a first state.

FIG. 5B illustrates the exemplary game interface shown in FIG. 5A in a second state.

FIG. 5C illustrates the exemplary game interface shown in FIGS. 5A and 5B in a third state.

FIG. 5D illustrates the exemplary game interface shown in FIGS. 5A-5C in a fourth state.

FIG. 5E illustrates the exemplary game interface shown in FIGS. 5A-5D in a fifth state.

FIG. 5F illustrates the exemplary game interface shown in FIGS. 5A-5E in a sixth state.

FIG. 5G illustrates the exemplary game interface shown in FIGS. 5A-5F in a seventh state.

FIG. 5H illustrates the exemplary game interface shown in FIGS. 5A-5G in an eighth state.

### DETAILED DESCRIPTION

Described herein are systems and methods for electronic gaming. The systems and methods described herein generate a game matrix having matrix positions that may be activated or deactivated in response to predefined triggers.

In exemplary embodiments, an electronic gaming system may include at least one memory that configured to record a state of a plurality of matrix positions of a game matrix. The state may indicate whether a matrix position is “active” or “inactive,” as described in further detail below. The electronic gaming system may further include at least one processor in communication with the at least one memory. The processor may be configured to, in response to a bonus feature being triggered (e.g., within a base game of a slot-style game or other electronic game), generate a game interface including the plurality of matrix positions configured to display cash on reel (COR) symbols or other symbols as described in further detail below. When a COR symbol is displayed, a credit value indicated by the COR symbol may be credited to a current player balance of the electronic game. Initially, each of the matrix positions is recorded as being in an active state.

The system may include a position tracking component for persistent or semi-persistent storage of the state of each matrix position (i.e., which matrix positions are active or inactive). For example, the position tracking component may store a data structure, such as a data map, including a field for each matrix position indicating the state of each matrix position (i.e., whether that matrix position is active or inactive). The position tracking component may update the state in response to determining certain predefined conditions of the electronic game have occurred as described herein.

During a course of the bonus feature, a series of random determinations, or “spins,” may be performed to determine whether to display COR symbols in respective matrix positions. For each spin, a separate random determination may be performed for each matrix position that is in the active state. For example, each matrix position may have an associated reel, and an RNG and/or table lookup may be used to determine a stopping position of the reel. For each matrix position that is in an inactive state, no such determination is performed and no COR symbol may be displayed. After a spin, any active matrix positions that do not display a COR symbol may then be recorded by the position tracking component as being in the inactive state. Thus, over the course of the bonus feature, fewer matrix positions are generally active with each spin until all matrix positions are inactive and the bonus feature ends. As described in further detail below, certain conditions within the game may trigger reactivation of inactive matrix positions, thereby extending a length of the bonus feature. In at least some implementations, performing a random determination for only the matrix positions designated as active for a given spin, rather than all matrix positions, may conserve computer processing and memory resources during execution of the bonus feature.

In some embodiments, the game interface further includes at least one metamorphic feature position configured to display a metamorphic feature symbol. For example, the game interface may include three metamorphic feature positions each configured to display a corresponding metamorphic feature symbol. In response to a random determination (e.g., performed concurrently with a spin in the base game or the bonus feature), a metamorphic feature symbol may be displayed in the at least one metamorphic feature position, and in response to the metamorphic feature symbol being displayed in the at least one metamorphic feature position, another random determination may be triggered based on which a corresponding metamorphic feature may be activated. In some such embodiments, the game interface may further include at least one metamorphic feature indicator, and in response to a metamorphic feature being activated, the metamorphic feature indicator may change in appearance (e.g., via animations, changes in color, changes in size, etc.).

In some embodiments, a type of metamorphic feature symbol that may be displayed is a “protect” metamorphic feature symbol that is associated with a first type of metamorphic feature referred to as a “protect” metamorphic feature. In response to the protect metamorphic feature being activated, a protect symbol may be displayed in at least one matrix position. When a protect symbol is being displayed in a matrix position, this matrix position may be prevented from being deactivated after a subsequent spin even if no COR symbol is displayed in the position. If a COR symbol is not displayed in this position following a subsequent spin, the protect symbol may be removed from the at least one matrix position. If a COR symbol is displayed in this position, the protect symbol may remain displayed and the position may remain active. In some embodiments, positions of the protect symbols may be recorded by the position tracking component.

In certain embodiments, a type of metamorphic feature symbol that may be displayed is a “multiplier” metamorphic feature symbol that is associated with another type of metamorphic feature referred to as a “multiplier” metamorphic feature. In response to the multiplier metamorphic feature being activated, at least one matrix position may be designated with a multiplier value. The matrix positions that are designated may be randomly determined, and if a matrix position already having a multiplier value is selected, the multiplier value may be boosted or increased to a higher multiplier value. The multiplier value may be applied to any COR symbols currently or subsequently displayed in the at least one matrix position, and the multiplier may persist throughout the remainder of the bonus feature even if the corresponding matrix position is deactivated at any point. In some embodiments, these multiplier values may be recorded by the position tracking component.

In some embodiments, a type of metamorphic feature symbol that may be displayed is a “revive” metamorphic feature symbol that is associated with another type of metamorphic feature referred to as a “revive” metamorphic feature. In response to the revive metamorphic feature being activated, at least one inactive matrix position may be selected to be reactivated. In some such embodiments, any matrix positions that are reactivated may automatically display a COR symbol. In some cases, activation of the revive metamorphic feature may result in an activation of and displaying a COR symbol in all matrix positions.

In certain embodiments, in response to each of the matrix positions being recorded by the position tracking component as being in the inactive state, which may trigger an end of the bonus feature, a random determination to award a credit value or jackpot may be performed. In some such embodiments, this determination may be performed based on if any of the metamorphic features described above are active. For example, for each active metamorphic feature, a random determination (e.g., reel spin) may be performed within the corresponding metamorphic feature position, and a jackpot may be awarded based on an outcome of this random determination. For example, if two metamorphic features are active, two of these random determinations may be performed, or if three metamorphic features are active, three of these metamorphic features may be performed. Accordingly, a larger number of metamorphic features being active at the end of the bonus feature leads to a greater likelihood that a jackpot is awarded.

A technical problem with game features that include aspects (e.g., metamorphic features) that may extend a length of the game features is that it may be difficult to control an RTP (return to player) and/or reduce use of computational resources for a given game instance. For example, if the revive metamorphic feature described above is repeatedly activated, the bonus may be extended indefinitely, which typically would require increasing amounts of computing and memory resources as the game continues. The systems described herein may utilize different lookup tables for the many different random determinations that occur during the bonus feature, and these lookup tables may be selected and differently weighted based on a current or past state of the game. For example, a lookup table may be selected based on how many instances of the revival metamorphic feature or other metamorphic feature have previously occurred, such that a likelihood of activating the revival metamorphic feature or other metamorphic feature again is reduced with each instance, thereby enabling a limit to be placed on a length of the bonus feature and its corresponding requirement for computing and memory resources. Additionally, performing a random determination to display a COR symbol only in active matrix positions, rather than all matrix positions, may reduce computer processing and memory requirements. Accordingly, the system described herein solves this technical problem by placing better controls on RTP and reducing the computational burden needed to execute a game feature.

Another technical problem exists in increasing variability and apparent randomness of display outcomes while maintaining understandability of the game to a user using a limited amount of display area and a predefined game layout (e.g., a matrix). The bonus feature described herein includes a great number of display elements that may be controlled based upon random determinations (e.g., using a random number generator and lookup table corresponding to the particular determination). These display elements include, for example, activation of the bonus feature, whether to display a COR symbol in each matrix position, activation of the metamorphic features, activation of effects of the metamorphic features, locations of where effects of the metamorphic features are activated, whether to award a jackpot upon completion of the bonus feature, and/or other display elements described herein. Accordingly, the system described herein solves this technical problem by increasing the randomness and/or variability of display outcomes that may be presented within a given display area and predefined game layout.

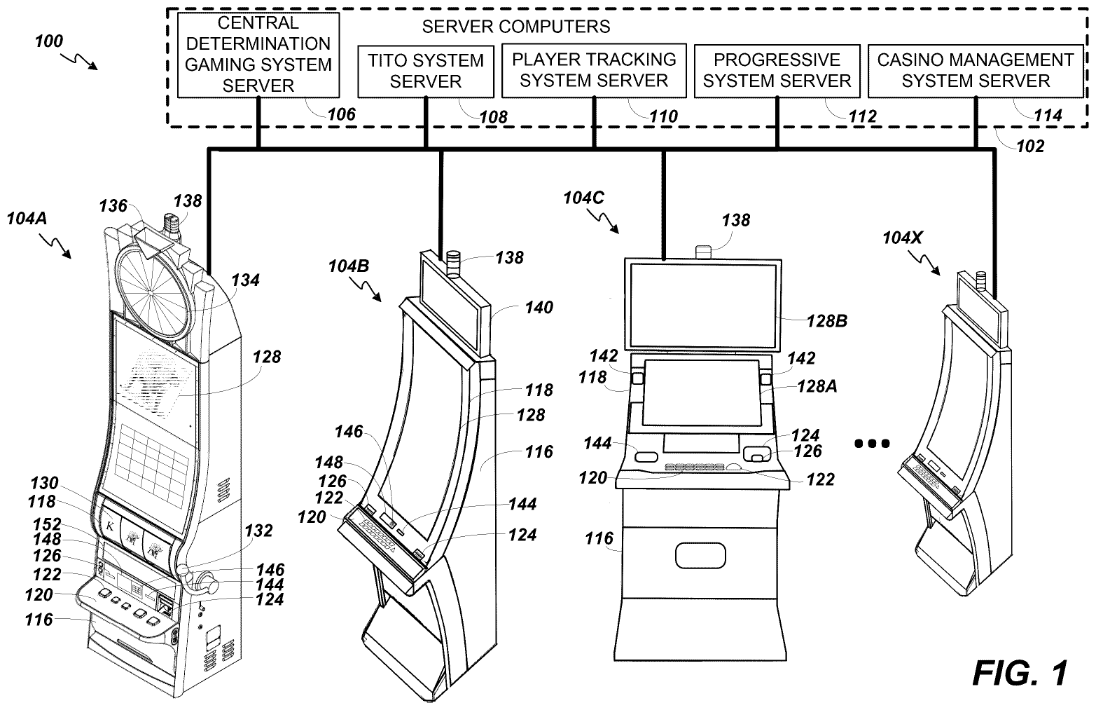

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

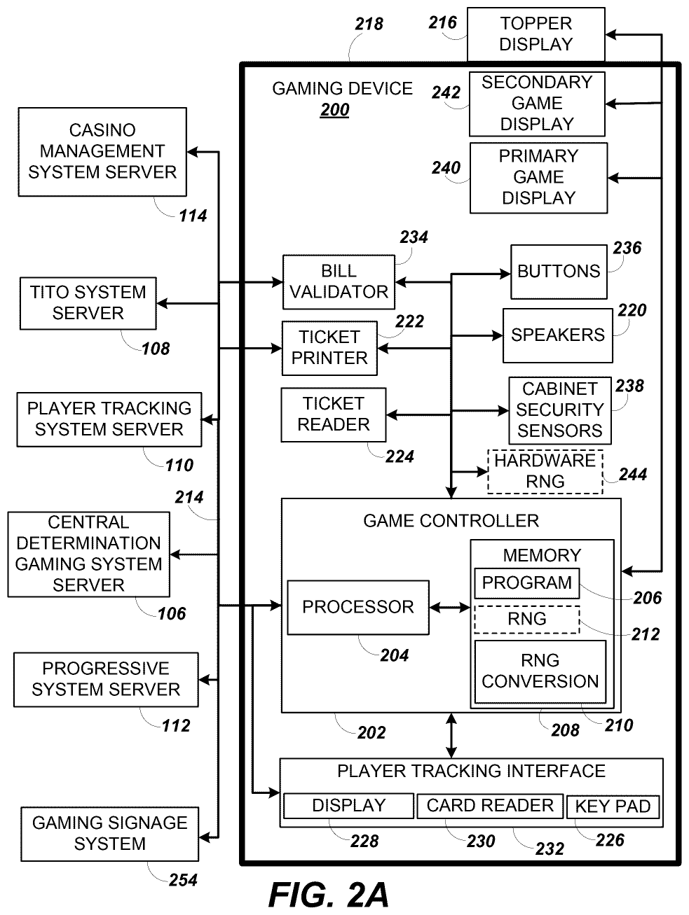

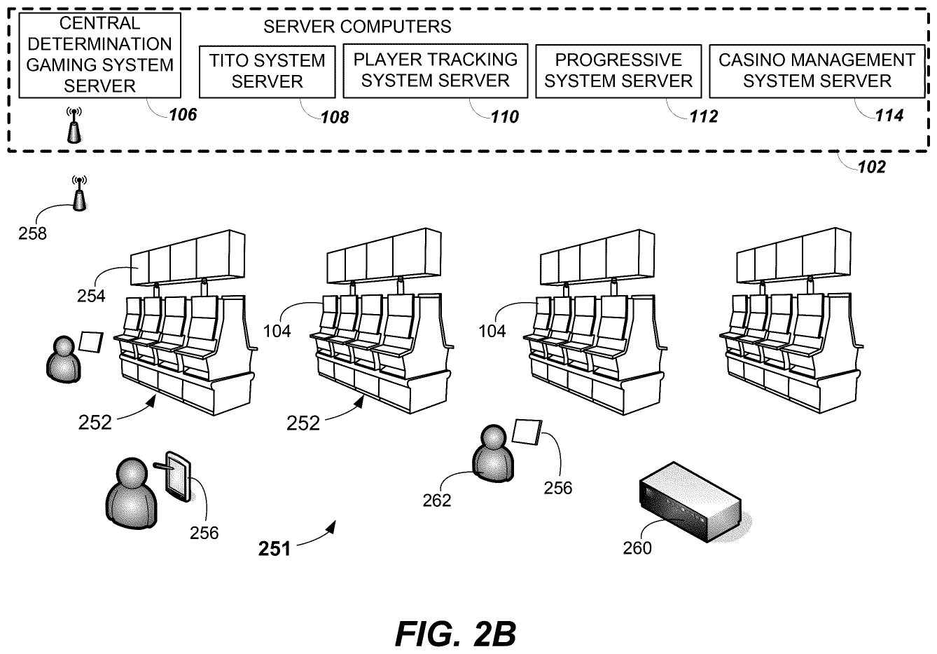

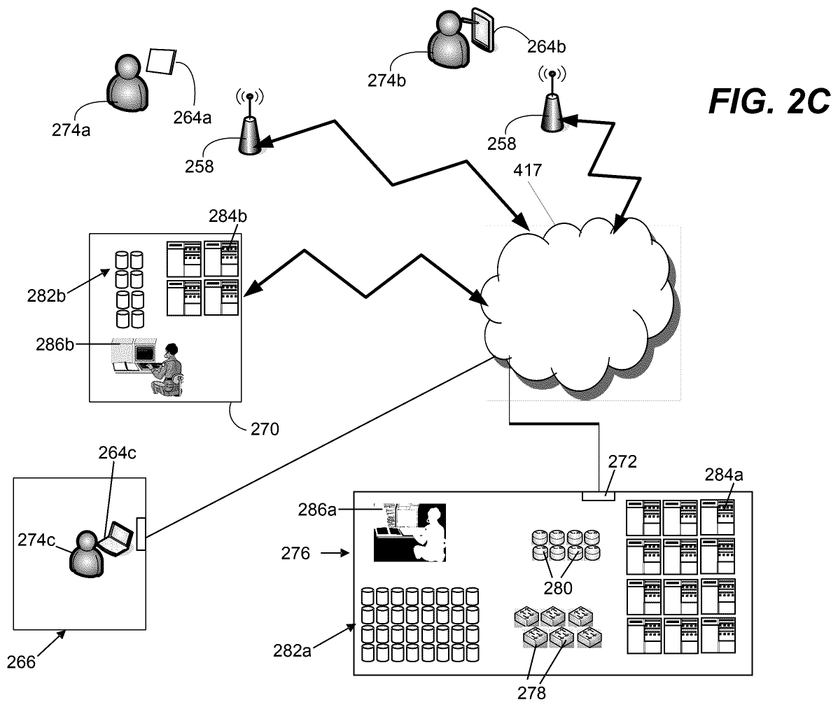

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

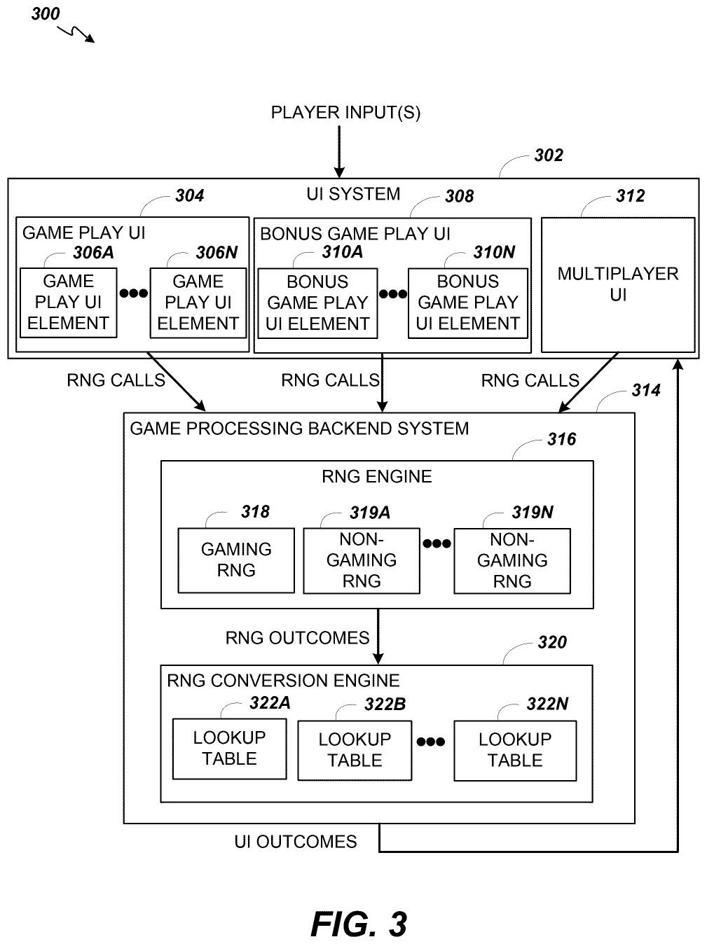

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

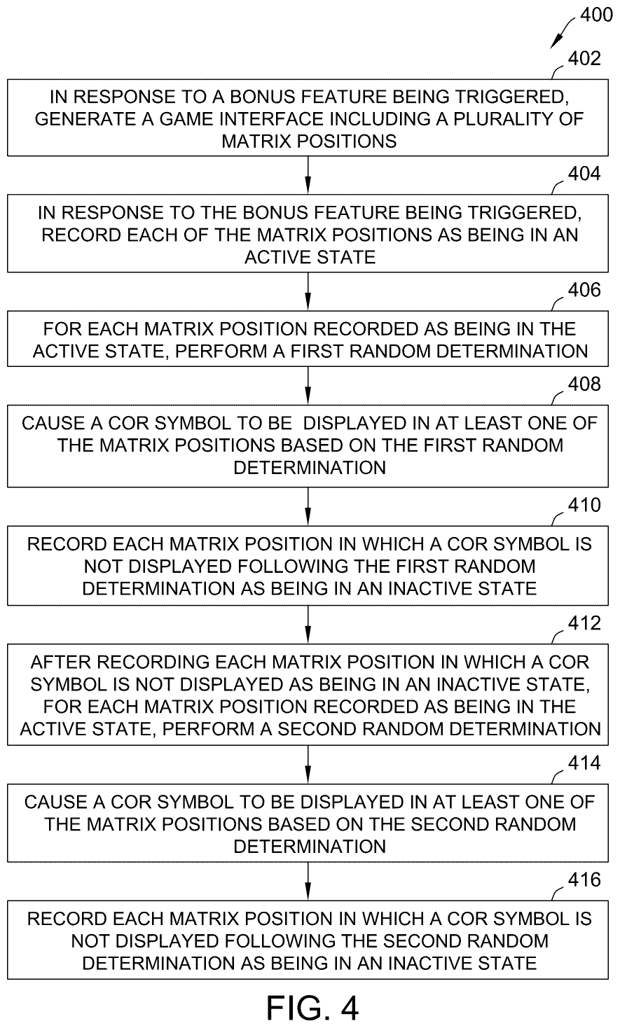

FIG. 4 is a flow chart illustrating an exemplary process 400 for evaluating and displaying an electronic game having matrix positions that may be activated or deactivated in response to predefined triggers in accordance with an exemplary embodiment of the present disclosure. Process 400 may be performed, for example, by gaming devices 104A-104X, server 106 (shown in FIG. 1), mobile gaming devices 256 (shown in FIG. 2), or some combination thereof. Gaming devices 104A-104X, server 106, and/or mobile gaming devices 256 (shown in FIG. 2) may be configured to execute a position tracking component for persistent or semi-persistent storage of the state of each matrix position (i.e., which matrix positions are active or inactive).

In the exemplary embodiment, process 400 may include, in response to a bonus feature being triggered, generating 402 a game interface including a plurality of matrix positions. Process 400 may further include, in response to a bonus feature being triggered, recording 404 (e.g., using the position tracking component) each of the matrix positions as being in an active state. Process 400 may further include, for each matrix position recorded as being in the active state, performing 406 a first random determination. Process 400 may further include causing 408 a COR symbol to be displayed in at least one of the matrix positions based on the first random determination. Process 400 may further include recording 410 (e.g., using the position tracking component) each matrix position in which a COR symbol is not displayed following the first random determination as being in an inactive state. Process 400 may further include, after recording each matrix position in which a COR symbol is not displayed as being in an inactive state, for each matrix position recorded as being in the active state, performing 412 a second random determination. Process 400 may further include causing 414 a COR symbol to be displayed in at least one of the matrix positions based on the second random determination. Process 400 may further include recording 416 (e.g., using the position tracking component) each matrix position in which a COR symbol is not displayed following the second random determination as being in an inactive state.

In some embodiments, the game interface may further include at least one metamorphic feature position configured to display a metamorphic feature symbol. A metamorphic feature symbol may be be displayed in the at least one metamorphic feature position, and in response to the metamorphic feature symbol being displayed in the at least one metamorphic feature position, a random determination to activate a metamorphic feature associated with the metamorphic feature symbol may be performed. The game interface further includes at least one metamorphic feature indicator, and in response to the metamorphic feature being activated, the metamorphic feature symbol associated with the activated metamorphic feature may change in appearance.

In certain embodiments, the metamorphic feature symbol is a protect metamorphic feature symbol associated with a protect metamorphic feature, and in response to the protect metamorphic feature being activated, a protect symbol may be displayed in at least one matrix position. In response to a protect symbol being displayed in the at least one matrix position, the at least one matrix position is prevented from being recorded as inactive, and if a COR symbol is not displayed in the matrix position following a random determination, the protect symbol may be removed from the at least one matrix position. In some embodiments, positions of the protect symbols may be recorded by the position tracking component.

In some embodiments, the metamorphic feature symbol is a multiplier metamorphic feature symbol associated with a multiplier metamorphic feature, and in response to the multiplier metamorphic feature being activated, at least one matrix position may be designated with a multiplier value. The multiplier value may be applied to any COR symbols currently or subsequently displayed in the matrix position. In some embodiments, positions of the multiplier values may be recorded by the position tracking component.

In some embodiments, the metamorphic feature symbol is a revive metamorphic feature symbol associated with a revive metamorphic feature, and in response to the revive metamorphic feature being activated, at least one matrix position currently recorded as being in the inactive state may be recorded (e.g., using the position tracking component) as being in the active state. In some such embodiments, reactivating the at least one matrix position may cause a COR symbol to displayed in the at least one matrix position.

In certain embodiments, in response to each of the matrix positions being recorded as being in the inactive state, a random determination may be performed to award a jackpot. For example, for each metamorphic feature active when each of the matrix positions is in the inactive state, a separate random determination may be performed (e.g., with an accompanying reel spin display) to award a jackpot or other credit value.

In some embodiments, a position tracking component may be executed that records the state of the plurality of matrix positions in the memory. For example, the position tracking component may store a data structure, such as a data map, including a field for each matrix position indicating the state of each matrix position (i.e., whether that matrix position is active or inactive). The position tracking component may update the state in response to determining certain predefined conditions of the electronic game have occurred.

Any of the random determinations described herein may be performed, for example, by performing a lookup in a lookup table base on an RNG output. The lookup table that is used for a random determination may be selected based upon, for example, which specific determination is being made, and in some cases, may be selected further based on a current state of the game. This enables controlling a likelihood of certain game outcomes to occur based on a current state of the game. For example, how likely a COR symbol is displayed in a particular matrix position may depend in part on, for example, a number of matrix positions that are currently active, a location of the matrix position within the game matrix, and/or a number of COR symbols displayed for a previous spin.

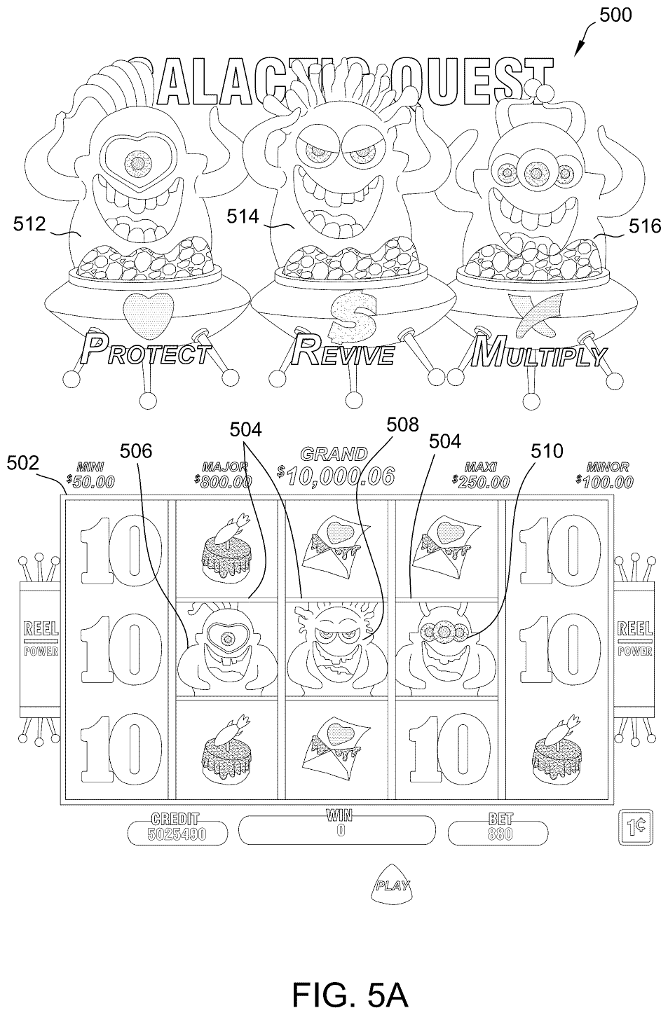

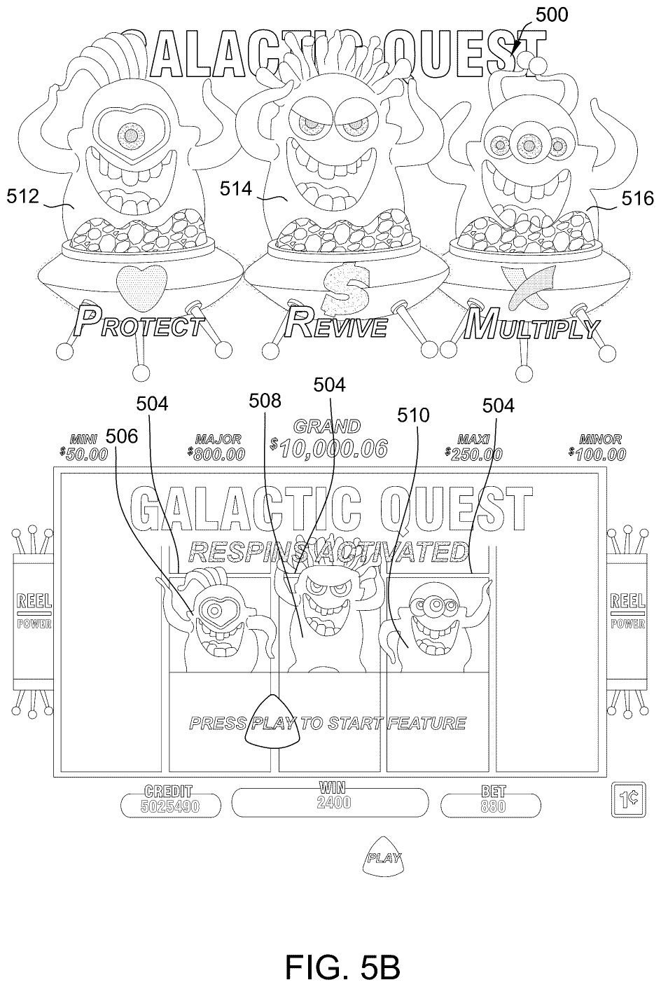

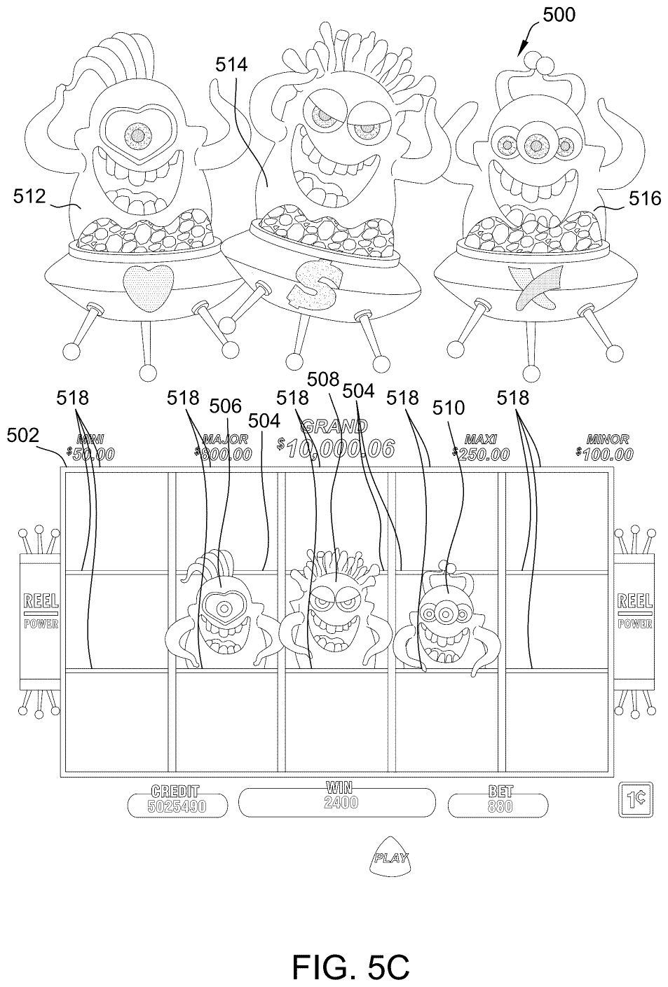

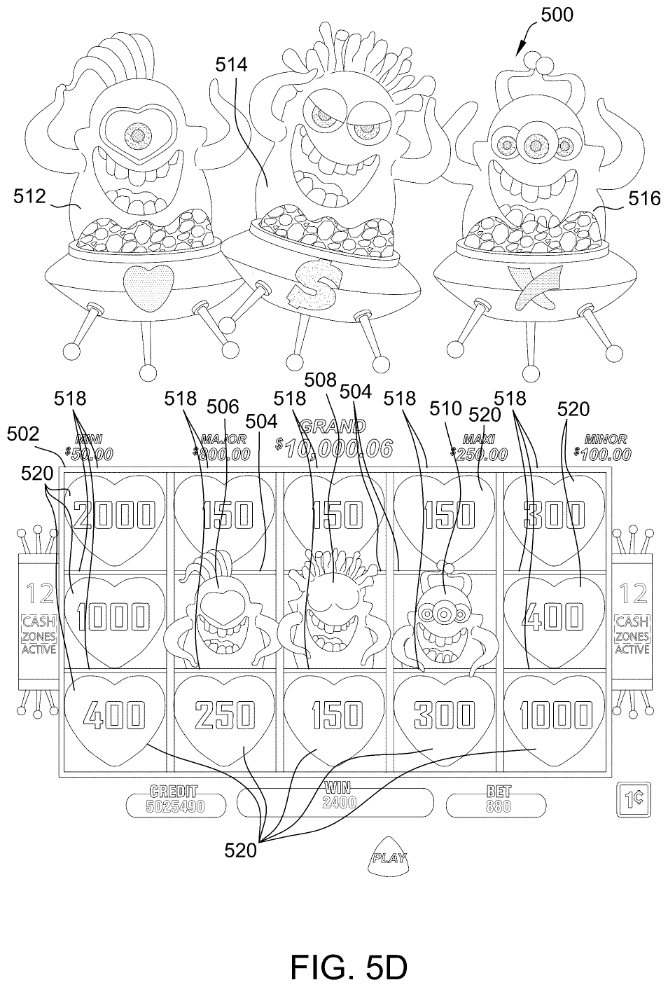

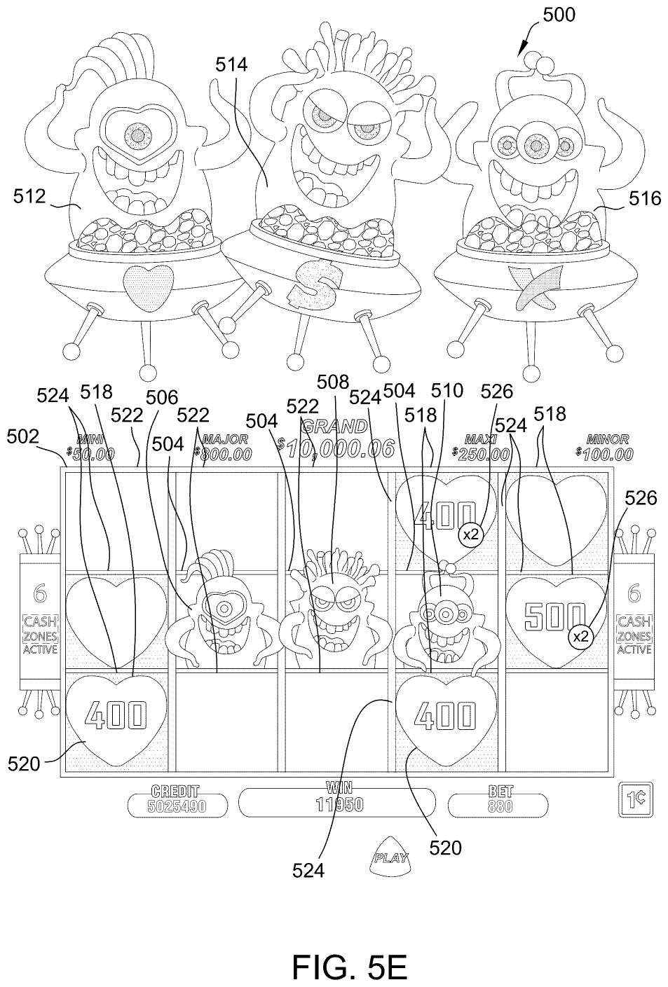

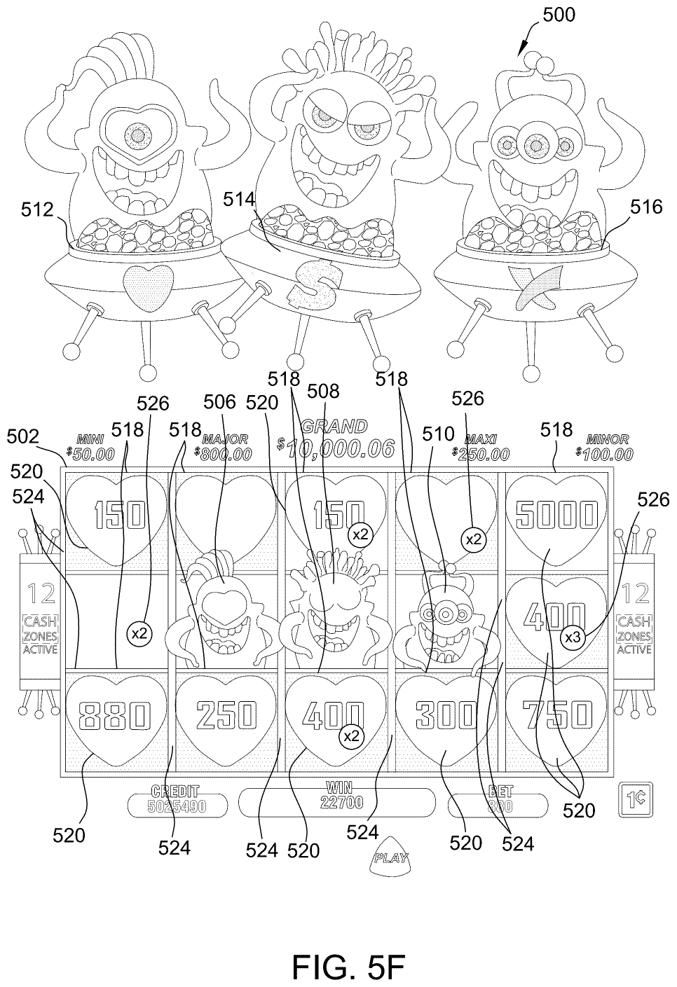

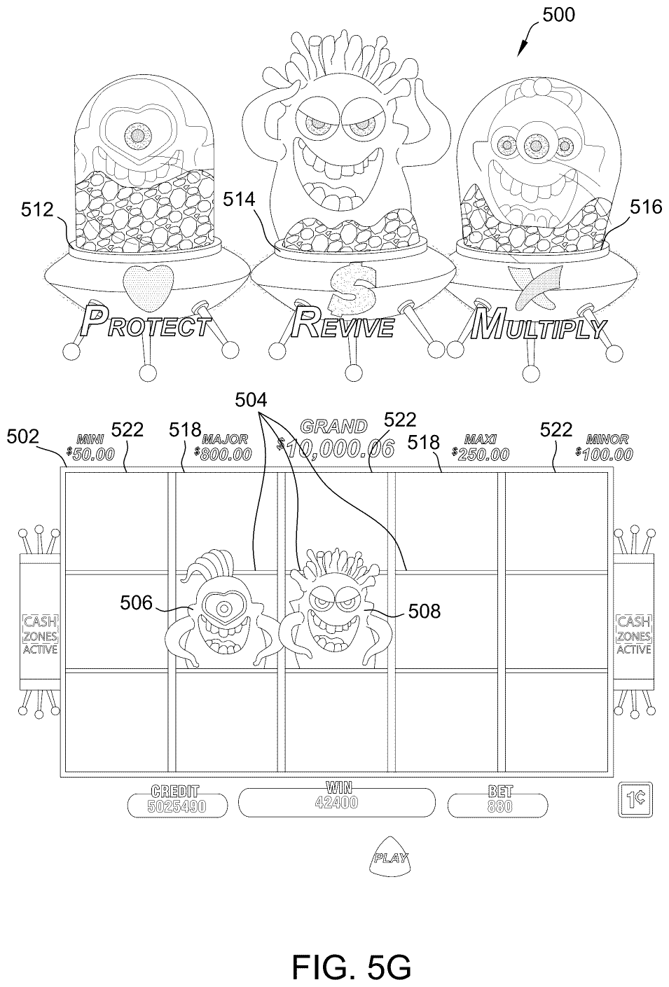

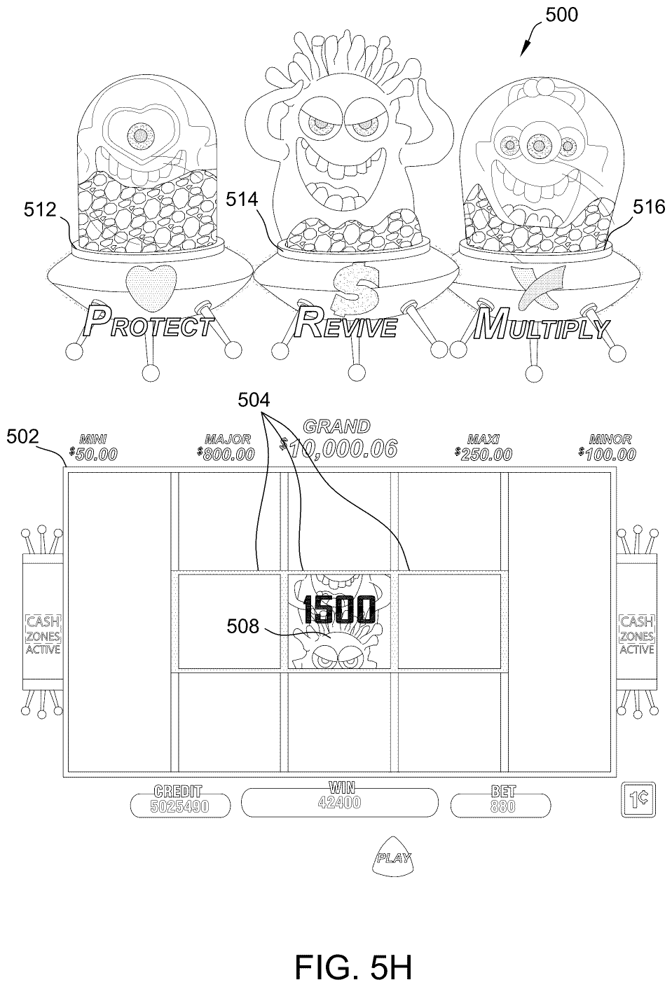

FIGS. 5A-5H illustrate an exemplary game interface 500 that may be displayed, for example, by gaming devices 104A-104X and/or mobile gaming devices 256 (shown in FIG. 2) while executing process 400 (shown in FIG. 4).

FIG. 5A illustrates a base game outcome that triggers the bonus game described herein. Game interface 500 includes a game matrix 502, which includes metamorphic feature positions 504 corresponding to a protect metamorphic feature, a revive metamorphic feature, and a multiplier metamorphic feature. A protect metamorphic feature symbol 506, a revive metamorphic feature symbol 508, and a multiplier metamorphic feature symbol 510 may be displayed in metamorphic feature positions 504. When one of these metamorphic feature symbols is displayed, an animation or other visual change may indicate a trigger of a potential activation of a corresponding one of protect indicator 512, revive indicator 514, or multiplier indicator 516, and in response to the trigger, a random determination may be performed to determine whether to activate the corresponding metamorphic feature. When one of these metamorphic features is activated during the base game, the bonus feature may be triggered.

FIG. 5B illustrates a state of game interface 500 that may occur to indicate the bonus feature has been triggered. Upon initially being triggered, game matrix 502 may be cleared with the exception of metamorphic feature positions 504, and game interface may prompt the user to start the bonus feature (e.g., by pressing a physical or virtual “play” button). In some embodiments, once the bonus feature is triggered, spins of the bonus feature may occur automatically after a predefined period of time. For example, the player may not need to press the “play” button or no such button may be present.

FIG. 5C illustrates an initial state of game interface 500 when the bonus feature is triggered. When first triggered, a plurality of active matrix positions 518 are initially activated, and thus capable of displaying a COR symbol 520 upon the next spin. To illustrate that active matrix positions 518 are activated, active matrix positions 518 may have highlighted edges as shown in FIG. 5C. In some embodiments, active matrix positions 518 may include additional or alternative display aspects to indicate that they are active, such as a certain color, brightness, and/or virtual motion of any symbols displayed in these active matrix positions 518.

FIG. 5D illustrates a state of game interface 500 after a revive metamorphic feature, as described above, has been triggered. Generally, a separate random determination is made for each active matrix position 518 to determine whether to display a COR symbol 520, which may result in less than all active matrix position 518 displaying a COR symbol 520. FIG. 5D illustrates a special case, in which because the revive metamorphic feature is currently active, a COR symbol 520 is generated in each active matrix position 518.

FIG. 5E illustrates a subsequent state of game interface 500 having certain inactive matrix positions 522 that are prevented from displaying a COR symbol 520 on the next spin. Inactive matrix positions 522 result from a COR symbol 520 failing to land or be displayed in an active matrix position 518 on a previous spin outcome. Inactive matrix positions 522 do not include the display elements such as highlighted edges that distinguish active matrix positions 518, and therefore indicate to the user that inactive matrix positions 522 are not eligible to display a COR symbol 520 upon the next spin unless reactivated (e.g., in response to a metamorphic feature being triggered.

FIG. 5E further illustrates protect symbols 524, which are persistent symbols that may be displayed when the protect metamorphic feature is active. When the protect metamorphic feature is activated, one or more random determinations may be made to display protect symbols 524 in certain active matrix positions 518. As described above, if a COR symbol 520 does not land in an active matrix position 518 for a given spin, that active matrix position 518 is generally deactivated for the next spin. However, if the active matrix position 518 includes a protect symbol 524, this active matrix position 518 will remain active even if a COR symbol 520 is not displayed. In these cases, protect symbol 524 may be removed from the active matrix position 518 that does not include a COR symbol 520 and the active matrix position 518 remains active in spite of not displaying a COR symbol 520. If a COR symbol 520 is displayed in an active matrix position 518 that includes a protect symbol 524, the active matrix position 518 may remain active and the protect symbol 524 may remain displayed in this active matrix position 518.

FIG. 5E further illustrates multipliers 526 that may be added to active matrix positions 518 in response to the multiplier metamorphic feature being activated. The multipliers 526 are applied to the award of any COR symbols 520 that land or are displayed in the corresponding active matrix positions 518. As shown in FIG. 5F, multipliers 526 persist throughout the bonus feature and may be boosted (i.e., increased in multiplier value) if the multiplier metamorphic feature is activated again.

FIG. 5F illustrates a state of game interface 500 subsequent to the state shown in FIG. 5E. As shown in FIG. 5F, active matrix positions 518 that were previously deactivated may be reactivated, for example, in response to the revive metamorphic feature being activated.

FIG. 5G illustrates game interface 500 in a state in which all matrix positions 518 have been converted to inactive matrix positions 522, which results in an end of the bonus feature. This state results if on a previous spin, no COR symbols 520 were displayed on any of the active matrix positions 518. This condition may trigger a random determination to award a credit value or jackpot if any of the metamorphic features are active. For example, as shown in FIG. 5H, if the revive metamorphic feature is active, a reel spin may be performed in the corresponding metamorphic feature position 504 to determine a credit value or jackpot to award. In some cases, more than one of the metamorphic features may be active, and a separate reel spin or determination to display a credit value or jackpot may be performed for each of the active metamorphic features. Accordingly, a likelihood of a credit value or jackpot being awarded at the end of the bonus feature may increase if a greater number of metamorphic features are active when the bonus feature ends.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming system comprising:
at least one memory with instructions stored thereon, the at least one memory further configured to record a state of a plurality of matrix positions; and
at least one processor in communication with the at least one memory, wherein the instructions, when executed by the at least one processor, cause the at least one processor to:
in response to a bonus feature being triggered, generate a game interface including the plurality of matrix positions;
in response to the bonus feature being triggered, record each of the matrix positions as being in an active state;
for each matrix position recorded as being in the active state, perform a first random determination;
cause a cash on reel (COR) symbol to be displayed in at least one of the matrix positions based on the first random determination; and
record each matrix position in which a COR symbol is not displayed following the first random determination as being in an inactive state.

2. The electronic gaming system of claim 1, wherein the instructions further cause the at least one processor to:
after recording each matrix position in which a COR symbol is not displayed as being in the inactive state, for each matrix position recorded as being in the active state, perform a second random determination;
cause a COR symbol to be displayed in at least one of the matrix positions based on the second random determination; and
record each matrix position in which a COR symbol is not displayed following the second random determination as being in the inactive state.

3. The electronic gaming system of claim 1, wherein the game interface further includes at least one metamorphic feature position configured to display a metamorphic feature symbol.

4. The electronic gaming system of claim 3, wherein the instructions further cause the at least one processor to:
cause the metamorphic feature symbol to be displayed in the at least one metamorphic feature position; and
in response to the metamorphic feature symbol being displayed in the at least one metamorphic feature position, randomly determine to activate a metamorphic feature associated with the metamorphic feature symbol.

5. The electronic gaming system of claim 4, wherein the game interface further includes at least one metamorphic feature indicator, and wherein the instructions further cause the at least one processor to, in response to the metamorphic feature being activated, cause a change in appearance of the at least one metamorphic feature indicator associated with the metamorphic feature.

6. The electronic gaming system of claim 4, wherein the metamorphic feature symbol is a protect metamorphic feature symbol associated with a protect metamorphic feature, and wherein the instructions further cause the at least one processor to:
in response to the protect metamorphic feature being activated, cause a protect symbol to be displayed in at least one matrix position;
in response to the protect symbol being displayed in the at least one matrix position, if a COR symbol is not displayed in the at least one matrix position following a random determination, prevent the at least one matrix position from being recorded as inactive; and
remove the protect symbol from the at least one matrix position.

7. The electronic gaming system of claim 4, wherein the metamorphic feature symbol is a multiplier metamorphic feature symbol associated with a multiplier metamorphic feature, and wherein the instructions further cause the at least one processor to:
in response to the multiplier metamorphic feature being activated, designate at least one matrix position with a multiplier value; and
apply the multiplier value to an award of any COR symbol currently or subsequently displayed in the at least one matrix position.

8. The electronic gaming system of claim 4, wherein the metamorphic feature symbol is a revive metamorphic feature symbol associated with a revive metamorphic feature, and wherein the instructions further cause the at least one processor to, in response to the revive metamorphic feature being activated, record at least one matrix position recorded as being in the inactive state as being in the active state.

9. The electronic gaming system of claim 8, wherein the instructions further cause the at least one processor to, in response to the revive metamorphic feature being activated, cause a COR symbol to be displayed in the at least one matrix position.

10. The electronic gaming system of claim 1, wherein the instructions further cause the at least one processor to, in response to each of the matrix positions being recorded as being in the inactive state, randomly determine to award a jackpot.

11. The electronic gaming system of claim 1, wherein the instructions further cause the at least one processor to execute a position tracking component that records the state of the plurality of matrix positions in the memory.

12. A method for electronic gaming, the method performed by at least one processor in communication with at least one memory configured to record a state of a plurality of matrix positions, the method comprising:
in response to a bonus feature being triggered, generating a game interface including the plurality of matrix positions;
in response to the bonus feature being triggered, recording each of the matrix positions as being in an active state;
for each matrix position recorded as being in the active state, performing a first random determination;
causing a cash on reel (COR) symbol to be displayed in at least one of the matrix positions based on the first random determination; and
recording each matrix position in which a COR symbol is not displayed following the first random determination as being in an inactive state.

13. The method of claim 12, further comprising:
after recording each matrix position in which a COR symbol is not displayed as being in the inactive state, for each matrix position recorded as being in the active state, performing a second random determination;
causing a COR symbol to be displayed in at least one of the matrix positions based on the second random determination; and
recording each matrix position in which a COR symbol is not displayed following the second random determination as being in the inactive state.

14. The method of claim 12, wherein the game interface further includes at least one metamorphic feature position configured to display a metamorphic feature symbol.

15. The method of claim 14, further comprising:
causing the metamorphic feature symbol to be displayed in the at least one metamorphic feature position; and
in response to the metamorphic feature symbol being displayed in the at least one metamorphic feature position, randomly determining to activate a metamorphic feature associated with the metamorphic feature symbol.

16. The method of claim 15, wherein the game interface further includes at least one metamorphic feature indicator, and wherein the method further comprises, in response to the metamorphic feature being activated, causing a change in appearance of the at least one metamorphic feature indicator associated with the metamorphic feature.

17. The method of claim 15, wherein the metamorphic feature symbol is a protect metamorphic feature symbol associated with a protect metamorphic feature, and wherein the method further comprises:
in response to the protect metamorphic feature being activated, causing a protect symbol to be displayed in at least one matrix position;
in response to the protect symbol being displayed in the at least one matrix position, if a COR symbol is not displayed in the at least one matrix position following a random determination, preventing the at least one matrix position from being recorded as inactive; and
removing the protect symbol from the at least one matrix position.

18. The method of claim 15, wherein the metamorphic feature symbol is a multiplier metamorphic feature symbol associated with a multiplier metamorphic feature, and wherein the method further comprises:
in response to the multiplier metamorphic feature being activated, designating at least one matrix position with a multiplier value; and
applying the multiplier value to an award of any COR symbol currently or subsequently displayed in the at least one matrix position.

19. The method of claim 15, wherein the metamorphic feature symbol is a revive metamorphic feature symbol associated with a revive metamorphic feature, and wherein the method further comprises, in response to the revive metamorphic feature being activated, recording at least one matrix position recorded as being in the inactive state as being in the active state.

20. At least one non-transitory computer-readable storage media having instructions embodied thereon, wherein when executed by at least one processor in communication with at least one memory configured to record a state of a plurality of matrix positions, the instructions cause the at least one processor to:
in response to a bonus feature being triggered, generate a game interface including the plurality of matrix positions;
in response to the bonus feature being triggered, record each of the matrix positions as being in an active state;
for each matrix position recorded as being in the active state, perform a first random determination;
cause a cash on reel (COR) symbol to be displayed in at least one of the matrix positions based on the first random determination; and
record each matrix position in which a COR symbol is not displayed following the first random determination as being in an inactive state.
